(19) United States
(12) Patent Application Publication
(10) Pub. No.: US 2025/0173250 A1
(43) Pub. Date: May 29, 2025

(54) DEPLOYING FUNCTIONAL SAFETY TESTING ENVIRONMENTS FOR A TEST SUITE

(71) Applicant: Red Hat, Inc., Raleigh, NC (US)

(72) Inventors: Rachel Elizabeth Sibley, Wake Forest, NC (US); Leigh Griffin, Kilmacthomas (IE)

(21) Appl. No.: 18/520,890

(22) Filed: Nov. 28, 2023

(51) Int. Cl. G06F 11/36

(52) U.S. Cl. CPC G06F 11/3698; G06F 11/3688

(57) ABSTRACT

The technology disclosed herein receives a test suite, identifies one or more parameter values for each test case of the test suite, obtains a plurality of Infrastructure as Code (IaC) variables for a respective test case based on the one or more parameter values, generates a corresponding IaC module for each IaC variable of the plurality of IaC variables, and instantiates a corresponding testing environment to execute the respective test case based on each IaC module associated with a respective IaC variable.

### TECHNICAL FIELD

The present disclosure is generally related to a computing environment, and more particularly, deploying functional safety testing environments for a test suite.

### BACKGROUND

Functional Safety (FuSa) in the automotive industry is of increasing importance, especially as vehicles integrate more complex electronics and software. FuSa testing is a crucial aspect of ensuring that safety-critical systems operate reliably and safely, especially when they encounter failures or unexpected situations.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level block diagram of an example computing environment, in accordance with one or more aspects of the present disclosure;

FIG. 2 depicts a system for automatically deploying functional safety (FuSa) testing environments for a test suite, in accordance with one or more aspects of the present disclosure;

FIG. 3 depicts a system for automatically deploying FuSa testing environments for a test suite, in accordance with one or more aspects of the present disclosure;

FIG. 4 depicts a flow diagram of an example method for automatically deploying FuSa testing environments for a test suite, in accordance with one or more aspects of the present disclosure;

FIG. 5 depicts a flow diagram of an example method for automatically deploying FuSa testing environments for a test suite, in accordance with one or more aspects of the present disclosure;

FIG. 6 depicts a block diagram of a computer system operating in accordance with one or more aspects of the present disclosure; and

FIG. 7 depicts a block diagram of an example computer system operating in accordance with one or more aspects of the present disclosure.

### DETAILED DESCRIPTION

Described herein are methods and systems for automatically deploying functional safety (FuSa) testing environments for a test suite. Automotive vehicles have evolved from being primarily mechanical to intricate combinations of hardware and software. This complexity introduces a vast array of potential failure points. Testing for all possible failure scenarios becomes a daunting task. Especially since these automotives operate in a wide range of environments—from freezing temperatures to scorching heat, from crowded urban areas to remote landscapes. Ensuring functional safety (FuSa) across all scenarios and environments adds layers of complexity to the testing process.

Establishing a virtualized environment, such as a container, for FuSa testing (e.g., a FuSa testing environment) requires precise configuration of diverse tools, systems, and processes to emulate multiple automotive system failures and ensure each component's optimal functionality. Such detailed setups can introduce initial and subsequent delays, particularly when components are improperly configured or require updates. Typically, multiple FuSa testing environments are utilized and tailored for different failure scenarios. Uniformity across multiple FuSa testing environments is necessary to guarantee consistent outcomes (or test results) since even slight configuration differences or software/tool version discrepancies can skew outcomes. Regular updates, patches, and maintenance, essential for maintaining consistency, not only consume significant time but also heighten the risk of human error.

Aspects of the present disclosure address the above-noted and other deficiencies by automatically provisioning and deploying FuSa testing environments for a test suite. The test suite may be an organized collection of test cases. For example, a set of Infrastructure as Code (IaC) variables may be generated according to various FuSa testing parameters. Each IaC variable corresponds to a FuSa testing parameter or combination of FuSa testing parameters and may be associated with a user-defined fragment of code that can, for example, set constraints on simulators (e.g., used to simulate environmental conditions), dictate an available amount of compute resources (e.g., RAM, CPU, etc.), set a number of inbound and/or outbound connections, etc. for a virtualized environment, such as a container, to replicate the FuSa testing parameter or combination of FuSa testing parameters. FuSa testing parameters may define normal and adverse conditions to be considered and tested to ensure that safety-critical systems behave predictably. Examples of FuSa testing parameters may include characteristics describing or otherwise related to automotive safety integrity level (ASIL) levels, failure modes, fault injection, safety mechanisms, internal conditions, safety requirements verification, coverage, end-to-end testing, environmental conditions, timing and latency, stress testing, redundancy testing, error handling, data integrity, interference, etc.

FuSa testing parameter values (or parameter values) are extracted from each test case of the test suite. FuSa testing parameter value refers to specific values or ranges of a FuSa testing parameter (e.g., 50 mph, ASIL level A, etc.). Each of the parameter values of a test case is used to retrieve, from the database of IaC variables, a corresponding IaC variable. Accordingly, a set of IaC variables is obtained for the test case. Each IaC variable of the set of IaC variables for the test is used to create (e.g., initialize) an IaC module (e.g. a data structure used to encapsulate code) in order to insert the IaC variable (e.g., individual fragments of code). IaC module refers to a data structure that consume and ingest IaC variables to expand corresponding fragments of code used to instantiate the virtualized environment. Accordingly, a set of IaC modules associated with the set of variables is created for the test case. In some embodiments, set of IaC modules may be combined into a single complex IaC module. The set of IaC modules (or complex IaC module) for the test case is used to instantiate a FuSa testing environment for the test case. The test case corresponding to the set of IaC variables obtained and included into the IaC module to instantiate the FuSa testing environment is inserted into the FuSa testing environment for testing. The FuSa testing environment may be a virtualized environment, such as a container. As a result, various FuSa testing environments are instantiated for the test suite in which each instantiated environment corresponds to a test case of the test suite.

Depending on the embodiment, the various FuSa testing environments may be limited to unique FuSa testing environments. More specifically, multiple test cases with identical set of IaC modules (or complex IaC module) causes a single FuSa testing environment to be instantiated for the multiple test cases. All test cases with identical set of IaC modules are inserted into the single FuSa testing environment for testing.

Depending on the embodiment, the various FuSa testing environments may be limited to a subset of FuSa testing environments. More specifically, a subset of the test cases of the test suite are identified as base test cases. In some embodiments, the base test cases may be identified by identifying test case testing a core functionality and the primary objectives of the application. In some embodiments, the base test cases may be identified based on a threshold number of IaC modules, indicating that the test case is testing core functionality and the primary objectives of the application. Any test case in which the number of IaC modules in the set of IaC modules associated with the test case is less than the threshold number of IaC modules is identified as a base test case. Accordingly, the set of IaC modules (or complex IaC module) for each base test case of the test suite is used to instantiate a FuSa testing environment. In other words, various FuSa testing environments are instantiated for the test suite in which each instantiated environment corresponds to a base test case of the test suite.

The set of IaC modules associated with each of the remaining test cases not identified as base test cases is compared with, one by one, the set of IaC modules associated each of the base test cases of the suite. Based on the comparison, the base test case of the test suite that produced the smallest delta for a remaining test case is selected for the remaining test case. Delta refers to the differences in configurations, resources, variables, and any other attributes of the set of IaC modules. The smallest delta indicates the small difference between any configurations, resources, variables, and other attributes within the set of IaC modules.

The remaining test case is inserted into a FuSa testing environment associated with the selected base test case. The remaining test case is assigned information indicating one or more IaC modules of the remaining test case that should be included in (and/or removed from) the FuSa testing environment to be accurately tested. Information may be an identifier specifying the IaC module. In order words, each FuSa testing environment associated with a base test case of the test suite may include one or more additional test cases from the test suite with information indicating changes that need to be made to the FuSa testing environment to make the FuSa testing environment suitable, in terms of accuracy, for testing the additional test case.

During the execution of the test suite, once a test case is executed in a FuSa testing environment, the FuSa testing environment is monitored for a subsequent test case to be executed. If the additional test case in the FuSa testing environment includes information indicating changes that need to be made to test the subsequent test case, the FuSa testing environment is modified and/or adjusted to accurately test the subsequent test case in view of the information. If the subsequent test case indicates one or more IaC modules to be included, the one or more IaC modules are included in the FuSa testing environment, and/or if the subsequent test case indicates one or more IaC modules to be removed, the one or more IaC modules are removed from the FuSa testing environment. As a result, the FuSa testing environment is modified and/or adjusted to accurately test the subsequent test case. Once modified and/or adjusted, the subsequent test case may be executed in the modified and/or adjusted FuSa testing environment. Otherwise, the FuSa testing environment is maintained (i.e., remains is unchanged, unmodified and/or unadjusted) the subsequent test case may be executed.

Advantages of the present disclosure include, but are not limited to, quickly and efficiently establishing FuSa testing environments for various conditions, thereby reducing the complexity and cost of establishing FuSa testing environments while increasing the accuracy of the testing results of the established FuSa testing environments.

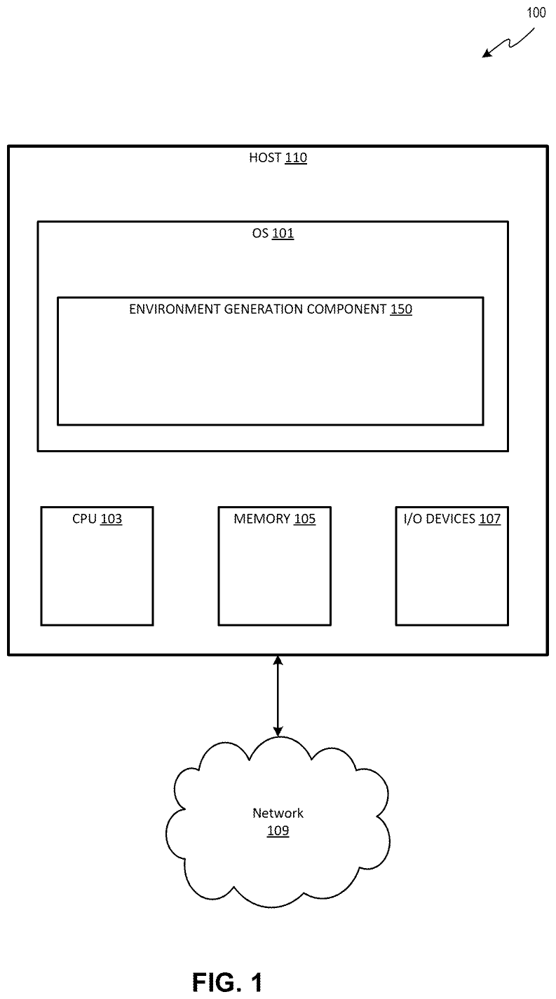

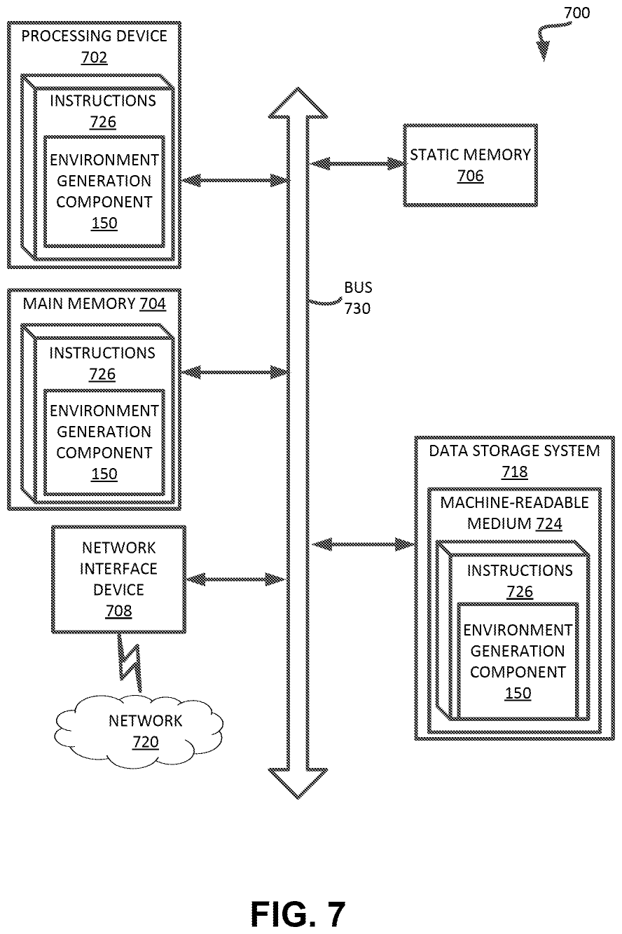

FIG. 1 is a block diagram that illustrates an embodiment of a computer system 100 in which embodiments of the present invention may operate. The computer system 100 may include a host 110. Host 110 may be a server, a workstation, a personal computer (PC), a mobile phone, a personal digital assistant (PDA), or any other suitable computing device. Host 110 may run an operating system (OS) 101 to manage its resources, such as one or more processors 103 communicatively coupled to memory devices 105, and I/O devices 107. Host 110 may run one or more processes. Each of the processes may be a program or a thread of a multi-threaded program. Each of the processes may be a user-space process or a system-level process. Further, each of the processes may run on host 110 or on a virtual machine hosted by host 110. In some embodiments, computer system 100 may be and/or include a computer system 700 as described in connection with FIG. 7.

Examples of “processors” (also referred herein as “processing devices” or CPUs) include various devices that are capable of executing instructions encoding arithmetic, logical, or I/O operations. In an illustrative example, a processor may follow Von Neumann architectural model and may include an arithmetic logic unit (ALU), a control unit, and a plurality of registers. In another aspect, a processor may be a single core processor which is capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket).

Examples of “memory devices” include volatile or non-volatile memory devices, such as RAM, ROM, EEPROM, or any other devices capable of storing data. Examples of “I/O devices” include devices providing an interface between a processor and an external device capable of inputting and/or outputting binary data.

In some embodiments, the computer system 100 may be accessible by remote systems via a network 109. The network 109 may be a private network (e.g., a local area network (LAN), a wide area network (WAN), intranet, etc.) or a public network (e.g., the Internet).

Host 110 may include an operating system 101 with one or more user space programs. The operating system may be any program or combination of programs that are capable of using the underlying computing device to perform computing tasks. The operating system may include a kernel comprising one or more kernel space programs (e.g., memory driver, network driver, file system driver) for interacting with virtual hardware devices or actual hardware devices (e.g., para-virtualization). User space programs may include programs that are capable of being executed by the operating system and in one example may be an application program for interacting with a user. Host 110 may comprise a computing device, and may refer to the computing device (e.g., physical machine), a virtual machine, or a combination thereof.

Host 110 may provide one or more levels of virtualization such as hardware-level virtualization, operating system level virtualization, other virtualization, or a combination thereof. Host 110 may provide hardware-level virtualization by running a hypervisor that provides hardware resources to one or more virtual machines. The hypervisor may be any program or combination of programs and may run on a host operating system or may run directly on the hardware (e.g., bare-metal hypervisor). The hypervisor may manage and monitor various aspects of the operation of the computing device, including the storage, memory, and network interfaces. The hypervisor may abstract the physical layer features such as processors, memory, and I/O devices, and present this abstraction as virtual devices to a virtual machine.

Host 110 (e.g., physical machine or virtual machine) may also or alternatively provide operating system level virtualization by running a computer program that provides computing resources to containers. Operating system level virtualization may be implemented within the kernel of the operating system and may enable the existence of multiple isolated containers. In one example, operating system level virtualization may not require hardware support and may impose little to no overhead because programs within the containers may use the system calls of the same underlying operating system. This enables host 110 to provide virtualization without the need to provide hardware emulation or be run in an intermediate virtual machine as may occur with hardware-level virtualization.

Operating system level virtualization may provide resource management features that isolate or limit the impact of resources of the containers on one another. The operating system level virtualization may provide a pool of resources that are accessible by a container and are isolated from other containers. The pool of resources may include file system resources (e.g., particular volume), network resources (e.g., particular network address), memory resources (e.g., particular memory portions), other computing resources, or a combination thereof. The operating system level virtualization may also limit a container's access to one or more computing resources by monitoring the containers activity and restricting the activity in view of one or more limits (e.g., quotas). The limits may restrict the rate of the activity, the aggregate amount of the activity, or a combination thereof. The limits may include one or more of disk limits, input/out (I/O) limits, memory limits, CPU limits, network limits, other limits, or a combination thereof. In one example, an operating system virtualizer provides the computing resources to containers. The operating system virtualizer may wrap an application in a complete file system that contains the code, runtime, system tools, system libraries and other programs installed on host that can be used by the application. In one example, the operating system virtualizer may be the same or similar to Docker for Linux®, ThinApp® by VMWare®, Solaris Zones® by Oracle®, or other program that automates the packaging, deployment, and execution of applications inside containers.

A container may refer to a resource-constrained process space of host 110 that can execute functionality of a program (or application). Containers may be referred to as a user-space instances, a virtualization engines (VE), or jails and may appear to a user as a standalone instance of the user space of an operating system. The containers may share the same kernel but may be constrained to only use a defined set of computing resources (e.g., CPU, memory, I/O). As illustrated, host 110 may include an environment generation component 150 that can automatically deploy a plurality of testing environments (e.g., containers) hosted on the computer system 100 for testing a test suite. In one implementation, the environment generation component 150 may be part of OS 101. In another implementation, the environment generation component 150 may be implemented as a program that is not part of OS 101.

Environment generation component 150 may identify a plurality of FuSa testing parameters. FuSa testing parameters refer to normal and adverse conditions to be considered and tested to ensure that safety-critical systems behave predictably. Examples of FuSa testing parameters may include an automotive safety integrity level (ASIL) level, a failure mode, a fault injection, a safety mechanism, an internal condition, a safety requirement, a code coverage, a requirement coverage, a end-to-end test, an environmental condition, a timing and latency requirement, a stress test, a redundancy test, an error handling event, a data integrity requirement, or an interference, etc.

ASIL levels (A to D), derived from ISO 26262, define the rigor needed for validation, with ASIL D being the strictest. Failure modes categorize how a system can fail, including component degradation, system malfunctions, and complete system failure. Fault injection introduces faults deliberately to understand system behavior and validate its response. Safety mechanisms validate under different conditions to determine whether unsafe system behavior is prevented or controlled. Safety requirements verification checks of specific safety requirements are met under defined operating conditions. Coverage (e.g., code coverage or requirement coverage) ensures that all parts of the software have been tested and all safety requirements are tested. End-to-end testing ensures that the entire system, including integrated components and software, functions safely. Environmental conditions simulate various environmental conditions like temperature, humidity, and electromagnetic interference to see how they impact safety functions. Timing and latency measure the time systems take to respond to inputs or failures to ensure they react within safe margins. Stress testing overloads the system to see how it behaves beyond its specified limits. Redundancy testing ensures that backup systems or processes activate correctly if primary systems fail. Error handling checks how the system handles errors, both anticipated and unanticipated. Data integrity ensures that data, especially safety-critical data, is accurately maintained throughout all processes. Interference assesses how different systems or components interfere with each other and ensures they don't compromise safety. Internal conditions (i.e., of an automotive) ensure safe and reliable operations during different speeds, rotations per minute (RPM), steering, braking, and more.

Environment generation component 150, based on the plurality of FuSa testing parameters, defines a plurality of Infrastructure as Code (IaC) variables. IaC, such as Terraform, AWS CloudFormation, Ansible, Puppet, and Chef, is an operational paradigm of managing and provisioning computing infrastructure through executable code. Defining the plurality of IaC variables includes for each IaC variables creating a IaC templates or scripts that allow for customization without changing the core logic of the code. Environment generation component 150 may define each IaC variable to include user-defined fragment of code that can, for example, set constraints on simulators (e.g., used to simulate environmental conditions), dictate an available amount of compute resources (e.g., RAM, CPU, etc.), set a number of inbound and/or outbound connections, etc. for a virtualized environment, such as a container, to replicate a FuSa testing parameter of the plurality of FuSa testing parameters or a combination of one or more of the plurality of FuSa testing parameters. Defining the IaC variable includes providing a name, a description, a type, and often a default value for the variable.

Environment generation component 150 may receive a test suite. The test suite may be an organized collection of test cases intended to test a specific application to be deployed on an automotive vehicle. Environment generation component 150 may create, for each test case of the test suite, a plurality of IaC modules for a respective test case. More specifically, environment generation component 150 retrieves, from the respective test case, a set of parameter values. Each parameter value of the set of parameter values specifies a value for a specific FuSa testing parameter. For example, the set of parameter values of the respective test case may indicate a specific ASIL level (e.g., ASIL B), a specific speed (e.g., 50 mph), a specific outside temperature (e.g., 80° F.), etc. Environment generation component 150 may select, using a rule-based list, an IaC variable of the plurality of IaC variables for each parameter value of the set of parameter values (or combination of parameter values). The rule-based list defines, for each IaC variable, allowed values or ranges. For example, a rule might specify that a specific variable (e.g., temperature variable), can only take a value between the range of extreme cold (e.g., 0° F. (−18° C.)) and extreme heat (e.g., 100° F. (38° C.)) or that a specific value (e.g., 80° F.) corresponds to a temperature variable.

Environment generation component 150 inserts the selected IaC variable with their corresponding parameter value into an IaC module of the plurality of IaC modules. Thus, each IaC module maintains (or organizes) one or more IaC variables. Environment generation component 150 instantiates, using the plurality of IaC modules, a testing environment. For example, the plurality of IaC modules provisions and configures resources and components that are necessary to support the deployment and execution of containers within a testing environment. Environment generation component 150 installs the application in the testing environment. Environment generation component 150 includes in the testing environment the test case of the test suite used to create the testing environment to be tested. In other words, each test case of the test suite may instantiate a standalone testing environment in which the application is deployed and tested in view of the respective test case. Depending on the embodiment, the plurality of IaC modules may be included in a single complex IaC module, which is subsequently used to instantiate the testing environment, deploy the application, and include the test case used to create the testing environment for testing.

In some embodiments, environment generation component 150 may analyze the test suite to identify a set of base test cases. Base test cases refer to a foundational test from which other tests develop. In other words, the base test case checks the core functionality, ensuring that the primary objectives of the application are met. As a result, a failure in the base test case suggests a fundamental issue. Thus, once the base test case is successful, more complex test cases can be explored.

Environment generation component 150 may instantiate, as previously described, a plurality of base testing environments. More specifically, for each base test case of the set of base test cases, a base testing environment is instantiated by environment generation component 150. As previously described, for each base test case, a plurality of IaC modules are created and combined into a complex IaC module. Each of the IaC modules is created by selecting an IaC variable associated with a parameter value of a set of parameter values of the respective base test case to be included with the parameter value in the IaC module.

Environment generation component 150 identifies test cases of the test suite other than the base test cases of the test suite (also referred to as remaining test cases). Environment generation component 150, for each of the remaining test cases, creates, as previously described, a plurality of IaC modules to be combined into a complex IaC module. Environment generation component 150 compares the complex IaC module of a respective remaining test case with a complex IaC module associated with each of the plurality of base testing environments. Based on comparing the complex IaC module of the respective remaining test case with each complex IaC module associated with a base testing environment of the plurality of base testing environments, environment generation component 150 may identify which base testing environment provides the smallest delta. Delta is determined by identifying differences in configurations, resources, variables, and any other attributes. Thus, the identified base testing environment providing the smallest delta indicates that the difference between configurations, resources, variables, and any other attributes is the smallest between the complex IaC module of the respective remaining test case and the complex IaC module of the identified base testing environment.

Environment generation component 150 identifies one or more IaC modules of the complex IaC module of the respective remaining test case and one or more IaC modules of the complex IaC module of the identified base testing environment that caused the delta. Environment generation component 150 inserts the respective remaining test case in the identified base testing environment marked with each identifier associated with the one or more IaC modules of the complex IaC module of the respective remaining test case and each identifier associated with the one or more IaC modules of the complex IaC module of the identified base testing environment.

Environment generation component 150 may monitor whether a previous test case (e.g., the base test case) was executed in the base testing environment. If the previous test case was executed in the base testing environment and an additional test case (e.g., a remaining test case) is available to be tested, environment generation component 150 may remove, using the identifiers associated with the one or more IaC modules of the complex IaC module of the identified base testing environment, the one or more IaC modules from the identified base testing environment. Concurrently, or subsequently, environment generation component 150 may insert, using the identifiers associated with the one or more IaC modules of the complex IaC module of the remaining test case, the one or more IaC modules of the complex IaC module of the remaining test case. As a result, the base testing environment may be updated to a desired state correspond to the needs of the remaining test case.

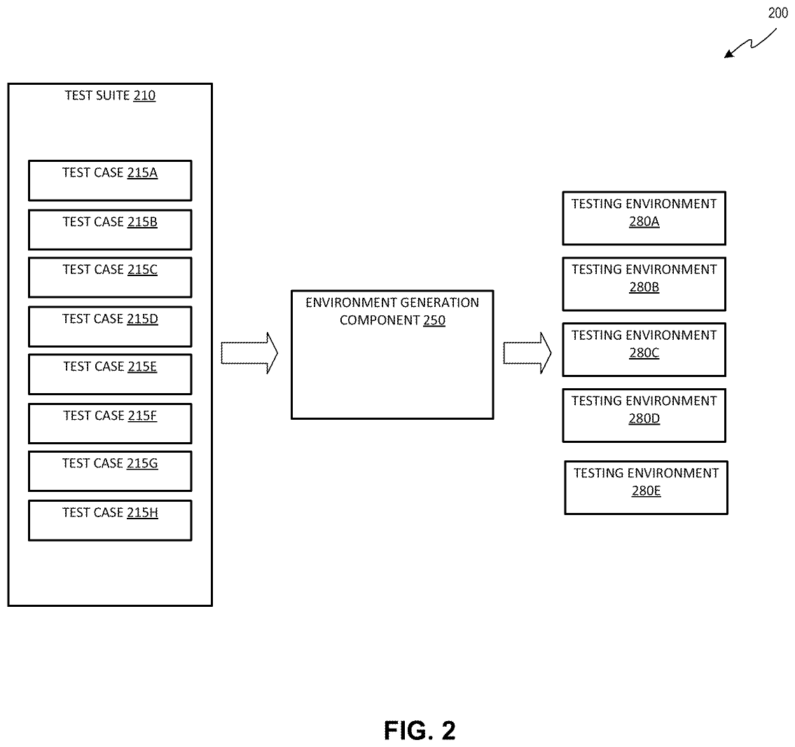

FIG. 2. depicts a system 200 for automatically deploying functional safety (FuSa) testing environments 280A-E for a test suite 210 in accordance with one or more aspects of the present disclosure. In particular, test suite 210 is inserted into an environment generation component 250 of system 200, which is similar to environment generation component 150 of FIG. 1, to deploy a plurality of testing environments (e.g., testing environments 280A-E) for testing of test suite 210.

Environment generation component 250 may receive test suite 210. Test suite 210 includes a set of test cases (e.g., test cases 215A-H). Each test case of test suite 210 includes one or more parameter values. Environment generation component 250 may identify, for each test case, the one or more parameter values. Environment generation component 250 retrieves, based on the one or more parameter values, corresponding pre-defined IaC variables.

Environment generation component 250 creates, based on the corresponding pre-defined IaC variables associated with a respective test case (e.g., test case 215A), an IaC module for each of the corresponding pre-defined IaC variables (e.g., a plurality of IaC modules for the respective test case (e.g., test case 215A)). The plurality of IaC modules for each test case is used to instantiate a testing environment.

In some embodiments, the plurality of IaC modules may be identical for multiple test cases of test suite 210 (e.g., the plurality of IaC modules for test cases E-H are identical). Accordingly, rather than instantiating a testing environment for each test case, only unique testing environments are instantiated. In other words, the plurality of IaC modules for each test case, which is not identical to another test case, is used to instantiate a testing environment. While the plurality of IaC modules of a test case is identical to the plurality of IaC modules of one or more other test cases is used to instantiate a single testing environment for all test cases with identical plurality of IaC modules.

The application to be tested is inserted into each instantiated testing environment, and each test case used to instantiate the testing environment is inserted into the testing environment. In the case of a single testing environment being instantiated for all test cases with identical plurality of IaC modules, the test cases with identical plurality of IaC modules are inserted into the single testing environment. For example, test case 215A instantiates testing environment 280A and inserts test case 215A; test case 215B instantiates testing environment 280B and inserts test case 215B; test case 215C instantiates testing environment 280C and inserts test case 215C; test case 215D instantiates testing environment 280D and inserts test case 215D; and test cases E-H instantiates testing environment 280E and inserts test cases E-H, since the plurality of IaC modules for each of test cases E-H were identical.

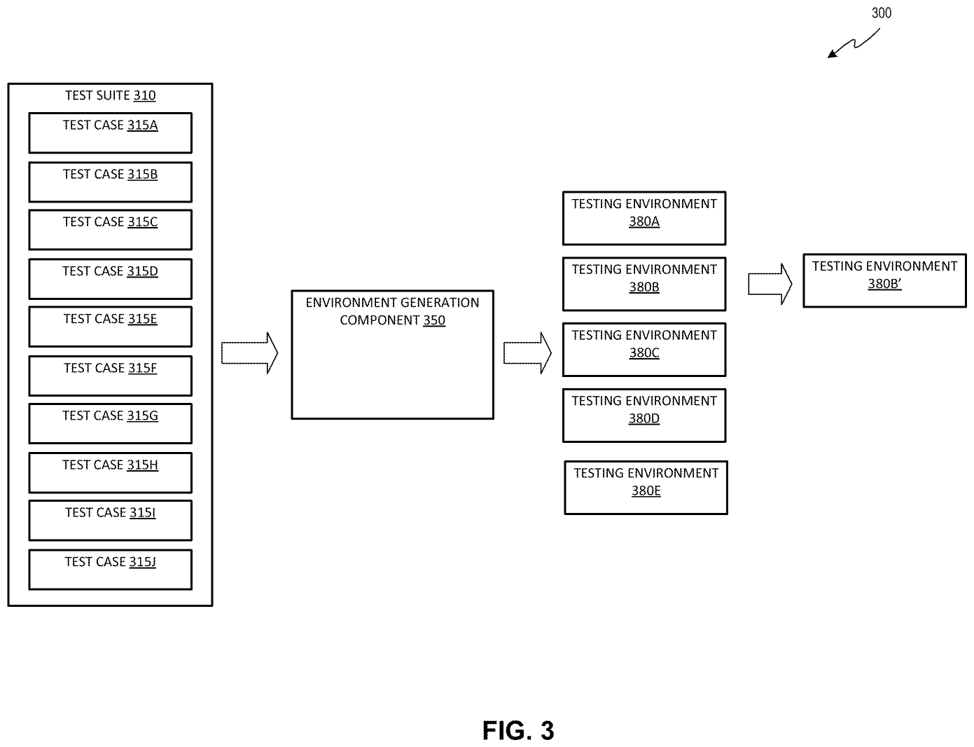

FIG. 3 depicts a system 300 for automatically deploying functional safety (FuSa) testing environments 380A-C for a test suite 310 in accordance with one or more aspects of the present disclosure. In particular, test suite 310 is inserted into an environment generation component 350 of system 300, which is similar to environment generation component 150 of FIG. 1, to deploy a plurality of base testing environments (e.g., base testing environments 380A-E) for testing of test suite 310.

Environment generation component 350 may receive test suite 310. Test suite 310 includes a set of test cases (e.g., test cases 315A-J). Environment generation component 350 may identify, for each test case of test suite 310, one or more parameter values. Environment generation component 350 retrieves, based on the one or more parameter values, corresponding pre-defined IaC variables. Environment generation component 350 creates, based on the corresponding pre-defined IaC variables associated with a respective test case (e.g., test case 315B), an IaC module for each of the corresponding pre-defined IaC variables (e.g., a plurality of IaC modules for the respective test case (e.g., test case 315B)).

Environment generation component 350 may identify a subset of test suite 310 identified as base test cases (e.g., test case 315B, test case 315D, and test case 315E). The plurality of IaC modules for each base test case (e.g., test case 315B) is used to instantiate a base testing environment (e.g., base testing environment 380A). The application to be tested is deployed to each of the plurality of base testing environments, and a corresponding base test case is inserted. Accordingly, test case 315B creates base testing environment 380A and inserts test case 315B, test case 315D creates base testing environment 380B and inserts test case 315D, and test case 315E creates base testing environment 380C and inserts test case 315E.

Environment generation component 350 identifies, for each of the remaining test cases (e.g., test case 315A, test case 315C, and test cases 315F-J), one or more IaC modules that need to be included into a base testing environment of the plurality of base testing environments 380A-E (e.g., base testing environment 380B) and/or one or more IaC modules that need to be removed from the base testing environment (e.g., base testing environment 380B) to create a suitable environment (e.g., base testing environment 380B′) for a respective remaining test case (e.g., test case 315A). Information (e.g., identifiers) associated with the one or more IaC modules to be included and/or the one or more IaC modules to be removed is assigned the respective remaining test case (e.g., test case 315A) and included in the base testing environment (e.g., base testing environment 380B). As previously described, the base testing environment of the plurality of base testing environments 380A-E, which receives the respective remaining test case with the information, is determined by identifying which base test case provides the smallest delta with the respective remaining test case. Additionally, information assigned to the respective remaining test case is identified and/or determined based on the delta.

After completion of a test case (e.g., the base test case (e.g., test case 315B)) in the base testing environment (e.g., base testing environment 380B), environment generation component 350 identifies the next test case (i.e., one of the remaining test cases included in the base testing environment (e.g., test case 315A)), and updates (or modifies) the base testing environment (e.g., base testing environment 380B) to a desired state of the base testing environment (e.g., base testing environment 380B′) by adding the one or more IaC modules to be included into the base testing environment (e.g., base testing environment 380B) and/or removing from the base testing environment (e.g., base testing environment 380B) the one or more IaC modules to be removed. Accordingly, test case 315A may be executed or performed in the desired state of the base testing environment (e.g., base testing environment 380B′).

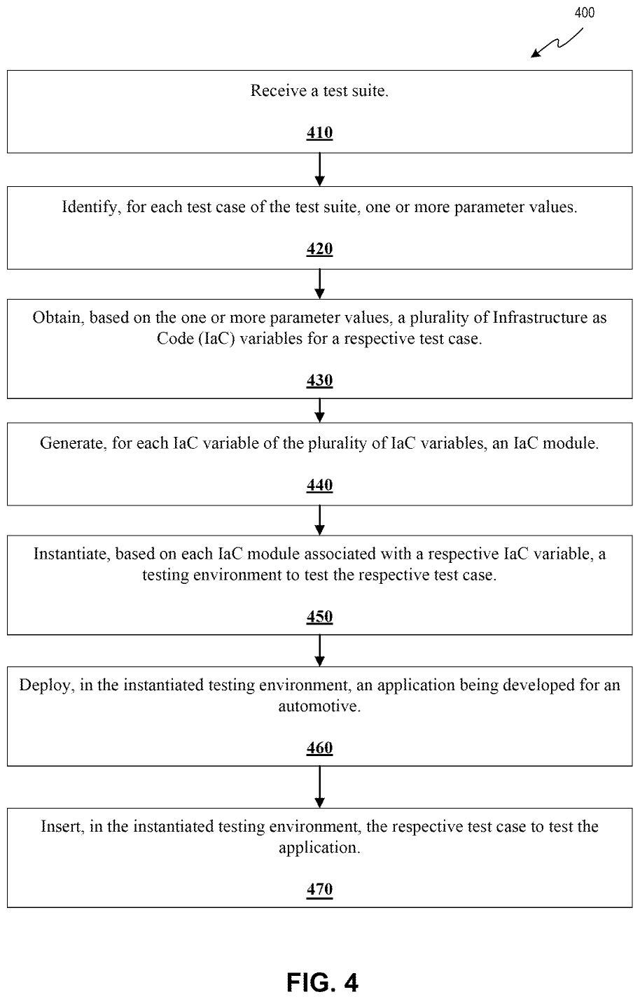

FIG. 4 depicts a flow diagram of an illustrative example of method 400 for automatically deploying FuSa testing environments for a test suite, in accordance with one or more aspects of the present disclosure. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processes implementing method 400 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 400 may be performed by environment generation component 150 as shown in FIG. 1 or by an executable code of a computing system (e.g., operating system).

Method 400 may be performed by a processing device of a computing system and may begin at block 410. At block 410, the processing device receives a test suite. The test suite is a collection of test cases used to test functional safety (FuSa) of an application being developed for an automotive. At block 420, the processing device identifies, for each test case of the test suite, one or more parameter values. As previously described, each parameter value specifies a value for a specific FuSa testing parameter. For example, the set of parameter values of the respective test case may indicate a specific ASIL level (e.g., ASIL B), a specific speed (e.g., 50 mph), a specific outside temperature (e.g., 80° F.), etc.

At block 430, the processing device obtains, based on the one or more parameter values, a plurality of Infrastructure as Code (IaC) variables for a respective test case. Each IaC variable corresponds to a FuSa testing parameter or a combination of FuSa testing parameters. FuSa testing parameter can be automotive safety integrity level (ASIL) levels, failure modes, fault injection, safety mechanisms, internal conditions, safety requirements verification, coverage, end-to-end testing, environmental conditions, timing and latency, stress testing, redundancy testing, error handling, data integrity, or interference.

At block 440, the processing device generates, for each IaC variable of the plurality of IaC variables, an IaC module. As previously described, generating the IaC module includes creating the IaC module and inserting the IaC variable into the created IaC module.

At block 450, the processing device instantiates, based on each IaC module associated with a respective IaC variable, a testing environment to test the respective test case. As previously described, each IaC module associated with a respective IaC variable is a plurality of IaC modules, which can be combined into a single complex IaC variable to instantiate the testing environment. At block 460, the processing device deploys, in the instantiated testing environment, an application being developed for an automotive. At block 470, the processing device inserts, in the instantiated testing environment, the respective test case to test the application.

Depending on the embodiment, the plurality of IaC modules may be identical for multiple test cases in the test suite. Accordingly, rather than instantiating a testing environment for each test case, only unique testing environments are instantiated.

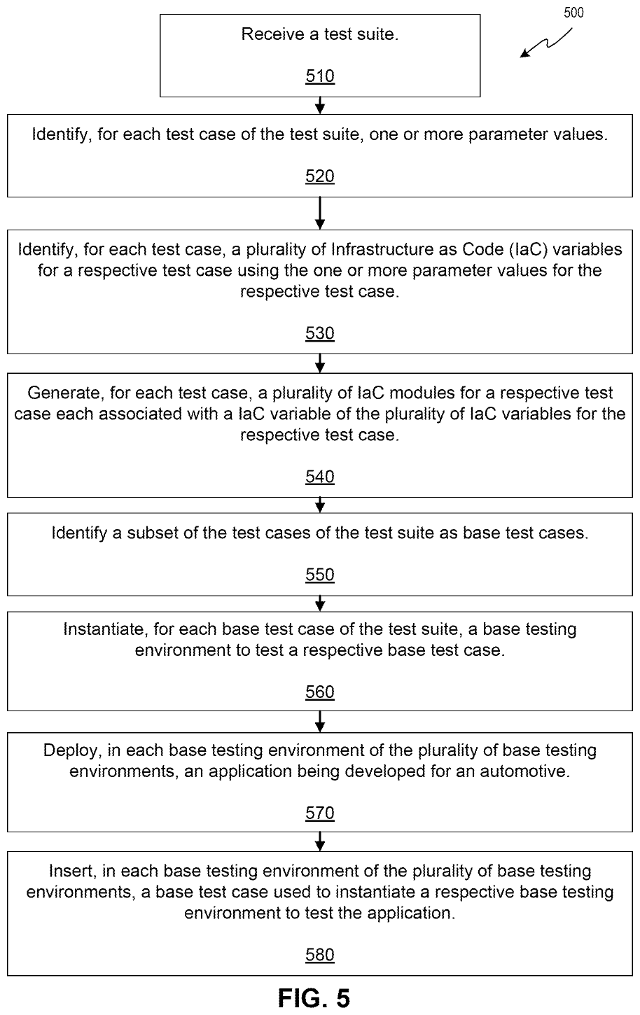

FIG. 5 depicts a flow diagram of an illustrative example of method 500 for automatically deploying FuSa testing environments for a test suite, in accordance with one or more aspects of the present disclosure. Method 500 and each of its individual functions, routines, subroutines, or operations may be performed by one or more processors of the computer device executing the method. In certain implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processes implementing method 500 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 500 may be performed by environment generation component 150 as shown in FIG. 1 or by an executable code of a computing system (e.g., operating system).

Method 500 may be performed by a processing device of a computing system and may begin at block 510. At block 510, the processing device receives a test suite. The test suite is a collection of test cases used to test functional safety (FuSa) of an application being developed for an automotive. At block 520, the processing device identifies, for each test case of the test suite, one or more parameter values. As previously described, each parameter value specifies a value for a specific FuSa testing parameter. For example, the set of parameter values of the respective test case may indicate a specific ASIL level (e.g., ASIL B), a specific speed (e.g., 50 mph), a specific outside temperature (e.g., 80° F.), etc.

At block 530, the processing device identifies, for each test case, a plurality of Infrastructure as Code (IaC) variables for a respective test case using the one or more parameter values for the respective test case. Each IaC variable corresponds to a FuSa testing parameter or a combination of FuSa testing parameters. FuSa testing parameter can be automotive safety integrity level (ASIL) levels, failure modes, fault injection, safety mechanisms, internal conditions, safety requirements verification, coverage, end-to-end testing, environmental conditions, timing and latency, stress testing, redundancy testing, error handling, data integrity, or interference.

At block 540, the processing device generates, for each test case, a plurality of IaC modules for a respective test case each associated with a IaC variable of the plurality of IaC variables for the respective test case. As previously described, generating the IaC module includes creating the IaC module and inserting the IaC variable into the created IaC module.

At block 550, the processing device identifies a subset of the test cases of the test suite as base test cases. As previously described, base test cases refer to test cases that test core functionality and the primary objectives of the application. As previously described, the base test cases may be identified based on a threshold number of IaC modules, indicating that the test case is testing core functionality and the primary objectives of the application. Any test case in which the number of IaC modules in the set of IaC modules associated with the test case is less than the threshold number of IaC modules is identified as a base test case.

At block 560, the processing device instantiates, for each base test case of the test suite, a base testing environment to test a respective base test case. In other words, a plurality of base testing environments are instantiated for the base test cases of the test suite. At block 570, the processing device deploys, in each base testing environment of the plurality of base testing environments, an application being developed for an automotive. At block 580, the processing device inserts, in each base testing environment of the plurality of base testing environments, a base test case used to instantiate a respective base testing environment to test the application.

Depending on the embodiment, the processing device may determine, for each test case not identified as a base test case, a delta between the plurality of IaC modules of a respective test case and the plurality of IaC modules of each of the base test cases. As previously described, delta refers to the differences in configurations, resources, variables, and any other attributes of the set of IaC modules. The processing device may identify, from the base test cases, a base test case with the smallest delta with the respective test case. As previously described, the smallest delta may indicate the small difference between any configurations, resources, variables, and other attributes within the set of IaC modules.

The processing device may identify, based on the delta, information indicating one or more IaC modules to be included or removed from a base testing environment associated instantiated by the base test case with the smallest delta. As previously described, the information may indicate one or more IaC modules that should be included in the base testing environment to accurately test a specific test case and/or information indicating one or more IaC modules that should be removed from the base testing environment to accurately test the specific test case. Information may be an identifier specifying the IaC module. The processing device may insert, in the base testing environment associated instantiated by the base test case with the smallest delta, the respective test case with the information to test the application.

Depending on the embodiment, the processing device may determine, for each base testing environment of the plurality of base testing environments, whether a first test case was executed in a respective base testing environment. Responsive to determining that a first test case was executed in the respective base testing environment, the processing device may determine whether a second test case is to be executed in the respective base testing environment. Responsive to determining that the second test case is to be executed in the respective base testing environment, the processing device updates, based on information associated with the second test case, the respective base testing environment to execute the second test case. As previously described, after completion of the first test case in the respective base testing environment, the second test case is identified, and the respective base testing environment is updated to a desired state of the base testing environment associated with the second test case by adding the one or more IaC modules into the respective base testing environment to be included and/or removing from the respective base testing environment the one or more IaC modules to be removed. Accordingly, second test case may be executed or performed in the desired state of the respective base testing environment. The desired state of the base testing environment resembles a testing environment that would have been instantiated based on the plurality of IaC modules associated with the second test case.

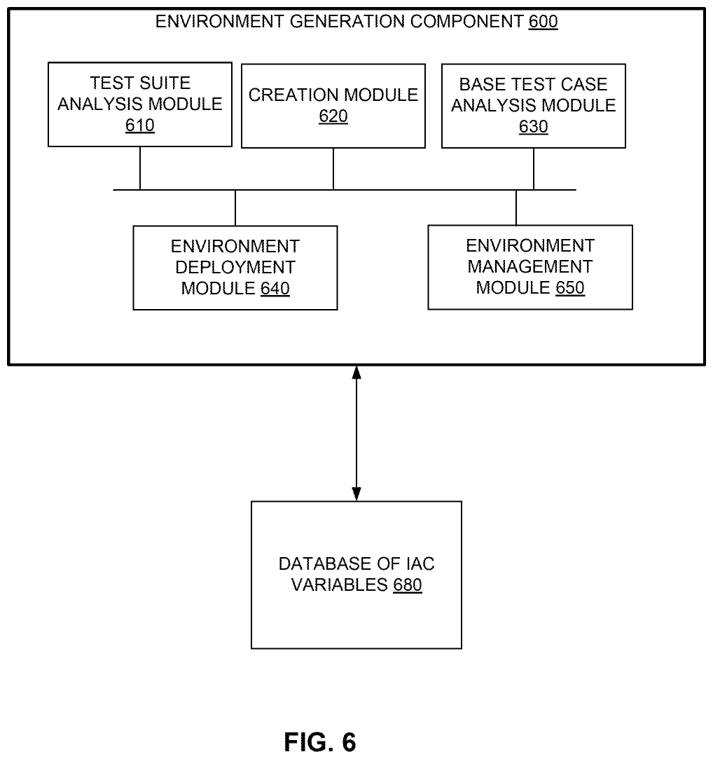

FIG. 6 depicts a block diagram of an environment generation component 600, in accordance with one or more aspects of the present disclosure. Environment generation component 600 may be the same or similar to environment generation component 150 of FIG. 1, environment generation component 250 of FIG. 2, and environment generation component 350 of FIG. 3 and may be implemented using one or more processing devices and one or more memory devices. In the example shown, environment generation component 600 may include a test suite analysis module 610, a creation module 620, a base test case analysis module 630, an environment deployment module 640, and an environment management module 650. Environment generation component 600 may be coupled to a database of IaC variables 680.

Database of IaC variables 680 includes a plurality of IaC variables. Each IaC variable of the plurality of IaC variables corresponds to a FuSa testing parameter or combination of FuSa testing parameters. As previously described, FuSa testing parameters refer to normal and adverse conditions to be considered and tested to ensure that safety-critical systems behave predictably. Examples of FuSa testing parameters may include automotive safety integrity level (ASIL) levels, failure modes, fault injection, safety mechanisms, internal conditions, safety requirements verification, coverage, end-to-end testing, environmental conditions, timing and latency, stress testing, redundancy testing, error handling, data integrity, interference, etc.

Environment generation component 600 may receive a test suite. The test suite may be an organized collection of test cases intended to test a specific application to be deployed on an automotive. Test suite analysis module 610 receives the test suite. In some embodiments, test suite analysis module 610 may identify, from each test case of the test suite, a set of parameter values. Environment generation component 600 assigns each set of parameter values to their corresponding test case of the test suite.

Creation module 620 retrieves a plurality of IaC variables, for each test case of the test suite, based on the set of parameter values associated with a respective test case. Retrieving the plurality of IaC variables based on the set of parameter values includes, for each parameter value identifying an IaC variable from the database of IaC variables 680. Creation module 620 creates, for each IaC variable of the plurality of IaC variables, an IaC module. Accordingly, creation module 620 creates a plurality of IaC modules, for each test case of the test suite, from the plurality of IaC variables associated with a respective test case. In some embodiments, creation module 620 may combine the plurality of IaC modules created for a test case of the test suite into a single complex IaC module for the test case. Creation module 620 assigns each plurality of IaC modules to their corresponding test case of the test suite.

Depending on the embodiment, base test case analysis module 630 may identify, from the test suite, one or more test cases that testing the core functionality and ensuring that the primary objectives of the application are met (e.g., base test case). Accordingly, base test case analysis module 630 may mark the one or more test cases in the test suite as base test cases.

Environment deployment module 640, in response to determining that no test case in the test suite is marked as a base test case, instantiates a testing environment for each test case of the test suite using the plurality of IaC modules associated with a respective test case. In some embodiments, environment deployment module 640 may determine that the plurality of IaC modules are identical among multiple test cases of the test suite. As a result, environment deployment module 640 instantiates a single testing environment for the multiple test cases of the test suite.

Environment deployment module 640, in response to determining that one or more test case in the test suite is marked as a base test case, instantiates a testing environment for each base test case of the test suite using the plurality of IaC modules associated with a respective base test case. Environment deployment module 640 deploys the application in each instantiated testing environment. Environment deployment module 640 further inserts into each instantiated testing environment the respective test case (or base test case) corresponding to the plurality of IaC modules used to instantiate a respective testing environment. In some embodiments, if a single testing environment is instantiated for multiple test cases, environment deployment module 640 inserts the multiple test cases into the single instantiated testing environment.

In some embodiments, if the testing environment were instantiated for base test cases only, environment deployment module 640 may identify, for each of the remaining test cases of the test suite, an instantiated testing environment to insert a respective remaining test case. In particular, environment deployment module 640 compares the plurality of IaC modules associated with the respective remaining test case with the plurality of IaC modules of each of base test case of the test suite. Environment deployment module 640 selects, from the base test cases of the test suite, a respective base test case in which the comparison between the plurality of IaC modules associated with the respective remaining test case and the plurality of IaC modules associated with the respective base test case produced the smallest delta. As previously described, delta is determined by identifying differences in configurations, resources, variables, and any other attributes. Environment deployment module 640 inserts the respective remaining test case into the instantiated testing environment associated with the selected respective base test case (e.g., selected instantiated testing environment).

In some embodiments, environment deployment module 640 may identify, from the plurality of IaC modules associated with the respective remaining test case, one or more IaC modules to be included in the selected instantiated testing environment to match a desired state of the instantiate testing environment. The desired state of the instantiate testing environment resembles a testing environment that would have been instantiated based on the plurality of IaC modules associated with the respective remaining test case. Accordingly, the one or more IaC modules to be included refers to one or more IaC modules that are not present in the selected instantiated testing environment but would be present in the desired state of the instantiate testing environment.

In some embodiments, environment deployment module 640 may identify, from the plurality of IaC modules associated with the respective remaining test case, one or more IaC modules to be included in the selected instantiated testing environment to match a desired state of the instantiate testing environment. The desired state of the instantiated testing environment resembles a testing environment that would have been instantiated based on the plurality of IaC modules associated with the respective remaining test case. Accordingly, the one or more IaC modules to be included refers to one or more IaC modules that are not present in the selected instantiated testing environment but would be present in the desired state of the instantiated testing environment.

In some embodiments, environment deployment module 640 may identify, from the plurality of IaC modules associated with the selected respective base test case, one or more IaC modules to be removed from the selected instantiated testing environment to match a desired state of the instantiate testing environment. Accordingly, the one or more IaC modules to be removed refers to one or more IaC modules that are present in the selected instantiated testing environment but would not be present in the desired state of the instantiated testing environment.

Accordingly, during the insertion of the respective remaining test case into the instantiated testing environment, environment deployment module 640 may assign to the respective remaining test case an identifier dictating the one or more IaC modules to be included in the instantiated testing environment and/or an identifier dictating the one or more IaC modules to be removed from the instantiated testing environment to modify the instantiated testing environment to a desired state of the instantiated testing environment to test the respective remaining test case in the instantiated testing environment.

Environment management module 650 may monitor each of the instantiated environments. In particular, for each instantiated environment, environment management module 650 determines, once a previous test case was executed in a respective instantiated environment, whether there is an additional test case to be tested in the respective instantiated environment. For each additional test case of the respective instantiated environment, environment management module 650 determines whether the additional test case includes identifiers dictating one or more IaC modules to be included in the instantiated testing environment and/or identifiers dictating the one or more IaC modules to be removed from the instantiated testing environment.

If the additional test case includes identifiers dictating one or more IaC modules to be included in the instantiated testing environment, environment management module 650 may include, using the identifiers, the one or more IaC modules associated with the additional test case into the instantiated testing environment. If the additional test case includes identifiers dictating one or more IaC modules to be removed from the instantiated testing environment, environment management module 650 may remove, using the identifiers, the one or more IaC modules used to instantiate the instantiated testing environment from the instantiated testing environment. Thus, once one or more IaC modules are included and/or removed in view of the identifiers associated with the additional test, environment management module 650 may indicate that the state of the instantiated testing environment has been modified (or upgraded) to a desired state and is suitable for testing the additional test case. Otherwise, if the additional test case does not include any identifiers, environment management module 650 may either not intervene to modify (or upgrade) the state of the instantiated testing environment or indicate that the state of the instantiated testing environment is suitable for testing the additional test case.

FIG. 7 depicts a block diagram of a computer system operating in accordance with one or more aspects of the present disclosure. In various illustrative examples, computer system 700 may correspond to computing environment 100 of FIG. 1. Computer system 700 may be included within a data center that supports virtualization. Virtualization within a data center result in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical environment, but requests for a hard disk or memory may be managed by a virtualization layer of a computing device to translate these requests to the underlying physical computing hardware resources. This type of virtualization results in multiple VMs sharing physical resources.

In certain implementations, computer system 700 may be connected (e.g., via a network, such as a Local Area Network (LAN), an intranet, an extranet, or the Internet) to other computer systems. Computer system 700 may operate in the capacity of a server or a client computer in a client-server environment, or as a peer computer in a peer-to-peer or distributed network environment. Computer system 700 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 700 may include a processing device 702, a volatile memory 704 (e.g., random access memory (RAM)), a non-volatile memory 706 (e.g., read-only memory (ROM) or electrically erasable programmable ROM (EEPROM)), and a data storage device, which may communicate with each other via a bus 708.

Processing device 702 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 700 may further include a network interface device 722. Computer system 700 also may include a video display unit (e.g., an LCD), an alphanumeric input device (e.g., a keyboard), a cursor control device (e.g., a mouse), and a signal generation device.

Data storage device may include a non-transitory computer-readable storage medium 724 on which may store instructions 726 encoding any one or more of the methods or functions described herein, including instructions for implementing method 700.

Instructions 726 may also reside, completely or partially, within volatile memory 704 and/or within processing device 702 during execution thereof by computer system 700, hence, volatile memory 704 and processing device 702 may also constitute machine-readable storage media.

While computer-readable storage medium 724 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

Other computer system designs and configurations may also be suitable to implement the system and methods described herein. The following examples illustrate various implementations in accordance with one or more aspects of the present disclosure.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “identifying,” “obtaining,” “generating,” “instantiating,” “deploying,” “inserting,” “obtaining,” “determining,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general-purpose computer system selectively programmed by a computer program stored in the computer system. Such a computer program may be stored in a computer-readable tangible storage medium.

The methods and illustrative examples described herein are not inherently related to any particular computer or other apparatus. Various general-purpose systems may be used in accordance with the teachings described herein, or it may prove convenient to construct more specialized apparatus to perform method 700 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
receiving a test suite;
identifying, for each test case of the test suite, one or more parameter values;
obtaining, based on the one or more parameter values, a plurality of Infrastructure as Code (IaC) variables for a respective test case;
generating, for each IaC variable of the plurality of IaC variables, a corresponding IaC module; and
instantiating, based on each IaC module associated with a respective IaC variable, a corresponding testing environment to execute the respective test case.

2. The method of claim 1, wherein the test suite is a collection of test cases used to test functional safety (FuSa) of an application being developed for an automotive vehicle.

3. The method of claim 1, further comprising:
deploying, in the instantiated testing environment, an application being developed for an automotive vehicle; and
inserting, in the instantiated testing environment, the respective test case to test the application.

4. The method of claim 1, wherein each IaC variable of the plurality of IaC variables corresponds to one of: a FuSa testing parameter or a combination of FuSa testing parameters.

5. The method of claim 4, wherein the FuSa testing parameter is associated with one of: an automotive safety integrity level (ASIL) level, a failure mode, a fault injection, a safety mechanism, an internal condition, a safety requirement, a code coverage, a requirement coverage, a end-to-end test, an environmental condition, a timing and latency requirement, a stress test, a redundancy test, an error handling event, a data integrity requirement, or an interference.

6. The method of claim 1, wherein instantiating the testing environment to execute the respective test case includes combining each IaC module associated with the respective IaC variable.

7. The method of claim 1, wherein generating, for each IaC variable of the plurality of IaC variables, the corresponding IaC module includes creating the IaC module and inserting the IaC variable into the created IaC module.

8. A system comprising:
a memory; and
a processor, operatively coupled with memory, to perform operations comprising:
receiving a test suite;
identifying, for each test case of the test suite, one or more parameter values;
obtaining, based on the one or more parameter values, a plurality of Infrastructure as Code (IaC) variables for a respective test case;
generating, for each IaC variable of the plurality of IaC variables, a corresponding IaC module;
instantiating, based on each IaC module associated with a respective IaC variable, a corresponding testing environment to execute the respective test case;
deploying, in the instantiated testing environment, an application being developed for an automotive vehicle; and
inserting, in the instantiated testing environment, the respective test case to test the application.

9. The system of claim 8, wherein the test suite is a collection of test cases used to test functional safety (FuSa) of the application being developed for an automotive vehicle.

10. The system of claim 8, wherein each IaC variable of the plurality of IaC variables corresponds to one of: a FuSa testing parameter or a combination of FuSa testing parameters.

11. The system of claim 10, wherein the FuSa testing parameter is associated with one of: an automotive safety integrity level (ASIL) level, a failure mode, a fault injection, a safety mechanism, an internal condition, a safety requirement, a code coverage, a requirement coverage, a end-to-end test, an environmental condition, a timing and latency requirement, a stress test, a redundancy test, an error handling event, a data integrity requirement, or an interference.

12. The system of claim 8, wherein instantiating the corresponding testing environment to execute the respective test case includes combining each IaC module associated with the respective IaC variable.

13. The system of claim 8, wherein generating, for each IaC variable of the plurality of IaC variables, the corresponding IaC module includes creating the IaC module and inserting the IaC variable into the created IaC module.

14. A non-transitory computer-readable storage medium comprising instructions that, when executed by a processing device, cause the processing device to perform operations comprising:
receiving a test suite;
identifying, for each test case of the test suite, one or more parameter values;
identifying, for each test case, a plurality of Infrastructure as Code (IaC) variables for a respective test case using the one or more parameter values for the respective test case;
generating, for each test case, a plurality of IaC modules for a respective test case each associated with a IaC variable of the plurality of IaC variables for the respective test case;
identifying a subset of the test cases of the test suite as base test cases;
instantiating, for each base test case of the test suite, a base testing environment to execute a respective base test case, wherein a plurality of base testing environments are instantiated for the base test cases of the test suite;
deploying, in each base testing environment of the plurality of base testing environments, an application being developed for an automotive vehicle; and
inserting, in each base testing environment of the plurality of base testing environments, a base test case used to instantiate a respective base testing environment to test the application.

15. The non-transitory computer-readable storage medium of claim 14, wherein identifying the subset of the test cases of the test suite as base test cases includes identifying which test case tests a core functionality and the primary objectives of the application, wherein the core functionality and the primary objectives of the application are determined by comparing a number of IaC modules in the plurality of IaC modules to a threshold number of IaC module.

16. The non-transitory computer-readable storage medium of claim 14, wherein the processing device is caused to perform operations further comprising:
determining, for each test case not identified as a base test case, a delta between the plurality of IaC modules of a respective test case and the plurality of IaC modules of each of the base test cases;
identifying, from the base test cases, a base test case with the smallest delta with the respective test case;
identifying, based on the delta, information indicating one or more IaC modules to be included or removed from a base testing environment instantiated by the base test case with the smallest delta; and
inserting, in the base testing environment instantiated by the base test case with the smallest delta, the respective test case with the information to test the application.

17. The non-transitory computer-readable storage medium of claim 16, wherein the processing device is caused to perform operations further comprising:
determining, for each base testing environment of the plurality of base testing environments, whether a first test case was executed in a respective base testing environment;
responsive to determining that the first test case was executed in the respective base testing environment, determining whether a second test case is to be executed in the respective base testing environment; and
responsive to determining that the second test case is to be executed in the respective base testing environment, updating, based on information associated with the second test case, the respective base testing environment to execute the second test case.

18. The non-transitory computer-readable storage medium of claim 14, wherein the test suite is a collection of test cases used to test functional safety (FuSa) of the application being developed for the automotive vehicle.

19. The non-transitory computer-readable storage medium of claim 14, wherein each IaC variable of the plurality of IaC variables corresponds to one of: a FuSa testing parameter or a combination of FuSa testing parameters, and wherein the FuSa testing parameter is associated with one of: an automotive safety integrity level (ASIL) level, a failure mode, a fault injection, a safety mechanism, an internal condition, a safety requirement, a code coverage, a requirement coverage, a end-to-end test, an environmental condition, a timing and latency requirement, a stress test, a redundancy test, an error handling event, a data integrity requirement, or an interference.

20. The non-transitory computer-readable storage medium of claim 14, wherein generating, for each test case, a plurality of IaC modules for a respective test case each associated with a IaC variable of the plurality of IaC variables for the respective test case, wherein each IaC module is created by inserting a corresponding IaC variable into the respective IaC module.
